(19) United States
(12) Patent Application Publication
(10) Pub. No.: US 2026/0023187 A1
(43) Pub. Date: Jan. 22, 2026

(54) NEUROMORPHIC RADIOGRAPHY AND X-RAY COMPUTED TOMOGRAPHY SYSTEM AND METHODS

(71) Applicant: Government of the United States as represented by the Secretary of the Air Force, Wright-Patterson AFB, OH (US)

(72) Inventor: Daniel Sparkman, Beavercreek, OH (US)

(21) Appl. No.: 19/184,714

(22) Filed: Apr. 21, 2025

Related U.S. Application Data
(60) Provisional application No. 63/671,840, filed on Jul. 16, 2024.

(51) Int. Cl. G01T 1/20; H04N 25/47

(52) U.S. Cl. CPC G01T 1/20184; H04N 25/47

(57) ABSTRACT

A neuromorphic radiography and computed tomography system including: a source of electromagnetic radiation; a scintillator, capable of fluorescing when struck by the electromagnetic radiation emitted by the source; and a neuromorphic camera comprising an array of pixels and having a field of view and configured to generate event data based on the fluorescence generated by the scintillator. The source emits the radiation in a field directed at an object and the object effects aspects of the electromagnetic radiation field, the scintillator receives the electromagnetic radiation and luminesces based on the electromagnetic radiation, the luminescence of the scintillator is captured by the neuromorphic camera to generate event data associated with luminescence events within the scintillator, wherein event data is generated each time an incidence of luminescence exceeds a threshold level of light within the field of view, and the event data is processed to generate a reconstruction of the object.

### CROSS REFERENCE TO RELATED APPLICATIONS

The present application claims the benefit of Provisional Application No. 63/671,840 filed Jul. 16, 2024, which is hereby incorporated by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to radiography systems and, more particularly, to neuromorphic radiography and x-ray computed tomography systems and methods.

### BACKGROUND OF THE INVENTION

Current tomography systems may utilize conventional pixel arrays for detectors that acquire data synchronously in a frame at a specified frame rate. The frame-based approaches can have poor contrast due to limited dynamic range and slow full-frame data collection due to bandwidth limitations. The limited dynamic range and slow data collection can result in long scan times. Long scan times may result in limited throughput of inspections, increase the likelihood of operator error or system malfunction, and can result in higher than necessary x-ray dosage rates or x-ray exposure of systems being examined using tomography systems. Hence, neuromorphic radiography and x-ray computed tomography system and methods may be required.

### SUMMARY OF THE INVENTION

The present invention overcomes the foregoing problems and other shortcomings, drawbacks, and challenges of conventional, frame-based computed tomography systems. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention a neuromorphic radiography and computed tomography system includes: a source of electromagnetic radiation; a scintillator, capable of fluorescing when struck by the electromagnetic radiation emitted by the source; and a neuromorphic camera comprising an array of pixels and having a field of view and configured to generate event data based on the fluorescence generated by the scintillator. The source emits the radiation in a field directed at an object and the object effects aspects of the electromagnetic radiation field, the scintillator receives the electromagnetic radiation and luminesces based on the electromagnetic radiation, the luminescence of the scintillator is captured by the neuromorphic camera to generate event data associated with luminescence events within the scintillator, wherein event data is generated each time an incidence of luminescence exceeds a threshold level of light within the field of view, and the event data is processed to generate a reconstruction of the object.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a schematic of one embodiment of a neuromorphic radiography and x-ray computed tomography system, according to one or more embodiments shown and described herein.

FIG. 2A depicts details of an exemplary scintillator assembly.

FIG. 2B depicts additional details of a scintillator and associated systems.

FIG. 2C depicts additional details of a scintillator and associated systems.

FIG. 3 depicts details of an exemplary neuromorphic camera.

FIG. 4 depicts exemplary images generated by the neuromorphic radiography and x-ray computed tomography system of FIG. 1.

FIG. 5 depicts an additional schematic of the embodiment of the neuromorphic radiography and x-ray computed tomography system of FIG. 1.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

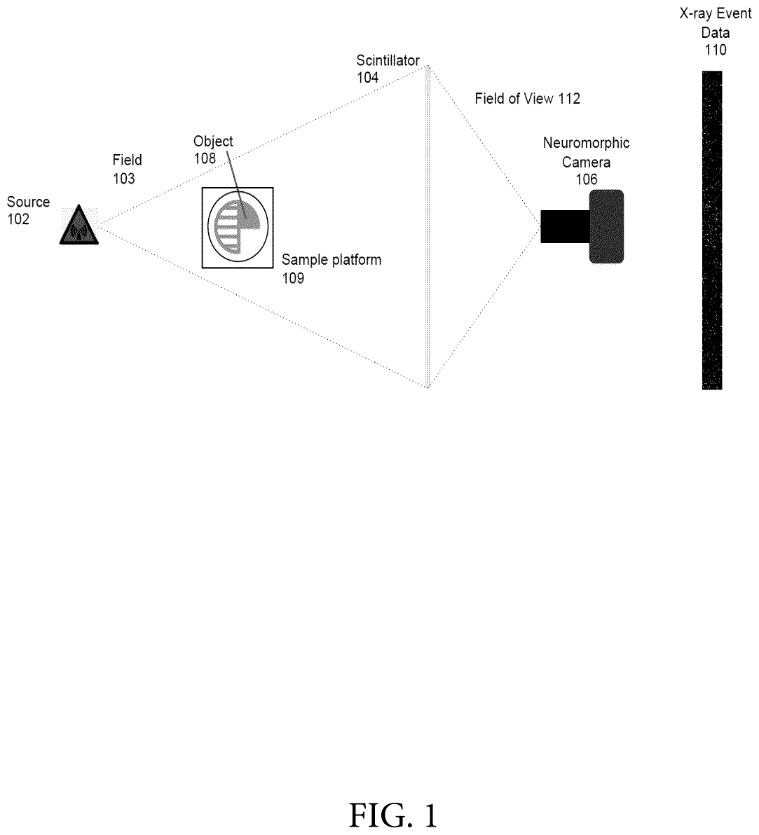

Referring to FIG. 1, a system schematic of a neuromorphic radiography and x-ray computed tomography system is shown. The system 100 includes a source 102, a scintillator 104, a neuromorphic camera 106 that may have a field of view (FOV) 112. The system 100 may be used to generate one or more tomographic images of an object 108 by generating x-ray event data 110.

The source 102 may be any source of electromagnetic radiation 102 (generally relatively high-energy electromagnetic radiation) capable of emitting such electromagnetic radiation in a field 103. In some embodiments, the electromagnetic radiation is x-ray radiation. As will be described in greater detail herein, the electromagnetic radiation may be emitted in the direction of the object 108 and the scintillator 104 may illuminate based on the relative level of interaction of the radiation and the object 108.

The scintillator 104 may be or comprise a material that fluoresces or otherwise emits radiation when struck by a charged particle or high-energy photon. In some embodiments, the scintillator 104 may comprise a photodetector for charged particles and gamma rays in which scintillations produced in a phosphor are detected and amplified by a photomultiplier or photodiode, giving an electrical output signal that may be measured. The scintillator 104 may include one or more scintillator materials such as, for example, one or more gaseous, liquid or solid, organic or inorganic (e.g., glass, single crystal, ceramics, etc.) materials. The scintillator 104 may operate in a process using three main subprocesses: conversion, energy transfer, and luminescence. In some embodiments, interaction of radiation with the scintillator 104 can occur through the photoelectric effect (PEE), Compton scattering, and electron-positron pair creation. Which of the three mechanisms will depend on the energy of the incident radiation. PEE and Compton scattering may be experienced at low energies (i.e., below 100 keV) up to medium energies (i.e., between 100 keV and 1 MeV). Above 1.02 MeV, electron-positron pair creation may be the dominant mechanism.

When radiation is absorbed by the scintillator material, the extra absorbed energy can create an electron hole pair. The electron hole pair may eventually migrate through the scintillation material, which migration may cause luminescence within the scintillation material. During luminescence, a photon may be emitted. The energy of the emitted photon may be dependent on multiple factors including the characteristics of the scintillation material itself and the energy of the incident radiation (i.e., energy of the radiation from the source).

The scintillation material may be selected based on multiple factors including, for example, light yield, energy resolution, decay time, afterglow, and stopping power. Light yield generally refers to the number of emitted photons per absorbed energy. Energy resolution is the ability of a material to discriminate between two radiations of slightly different energies. Decay time may refer to the kinetics of the light response and is often referred to as tau (t). Afterglow may refer to residual light output occurring after the primary decay time of the main luminescent centers. Stopping power may refer to the efficiency with which photons are absorbed.

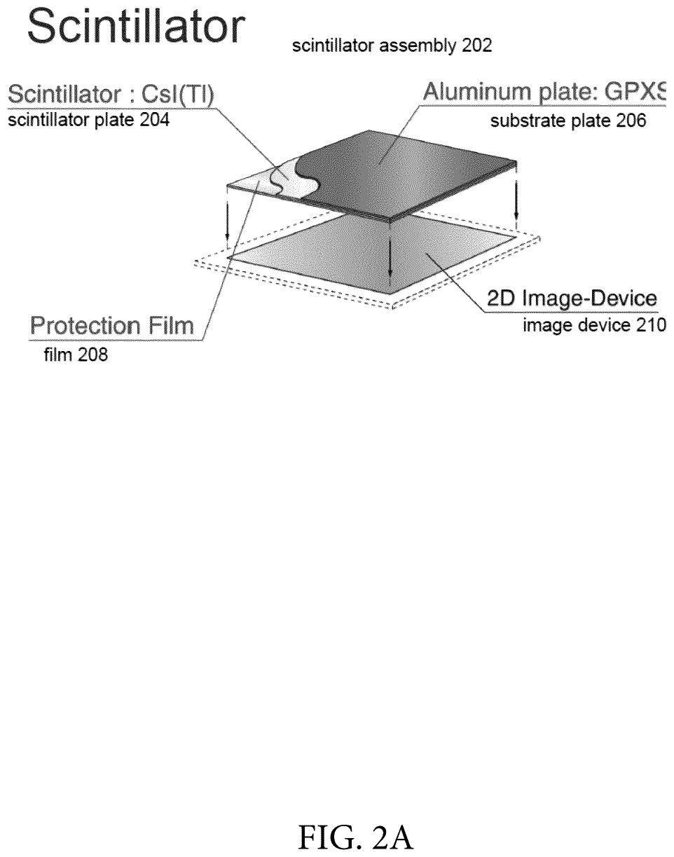

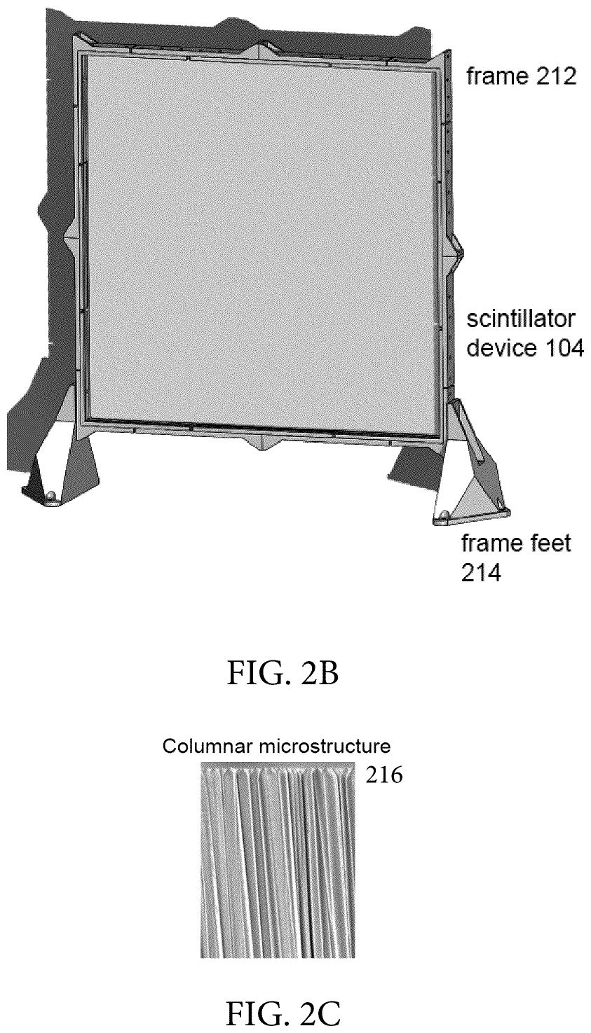

Referring to FIG. 2, in some embodiments, the scintillator 104 may comprise a scintillator assembly 202 including a scintillator plate 204, a substrate plate 206, and a film 208, which may be assembled to form a two-dimensional image device 210. The image device 210 may be housed in a frame 212 with one or more frame feet 214 that enable the scintillator 104 to stand vertically. The scintillator plate 204 may convert x-ray photons or other electromagnetic radiation to visible light. The substrate plate 206 can comprise a metal or other material (e.g., aluminum) and can have a columnar microstructure similar to the zoomed in view of the columnar microstructure 216. In some embodiments, the substrate plate may have a thickness of 1 mm, but embodiments are not limited to such dimensions and plates with other dimensions are considered (e.g., 2 mm, 3, mm, 4-10 mm, 10-20 mm, etc.) In some embodiments, the scintillator plate 204 may be a Cesium Iodide, activated with Thalium (CsI(TI)) scintillator plate. Other types of scintillator plates are considered, for example, a CsI, activated with Sodium (CsI(Na)) plate, a CsI plate, etc. In some embodiments, the scintillator plate 204 may have a thickness of 400 microns, but embodiments are not limited to such dimensions and scintillator plates with other dimensions are considered based on the energy of the source (e.g., 250 μm, 600 μm, etc.)

The frame 212 may be a three-dimensionally printed structure. In some embodiments, the frame 212 may measure approximately 18 inches×18 inches, but embodiments can be any size and are not limited to these dimensions. Generally, the frame 212 is substantially the same size as the scintillator plate 204 and holds the scintillator plate 204 upright.

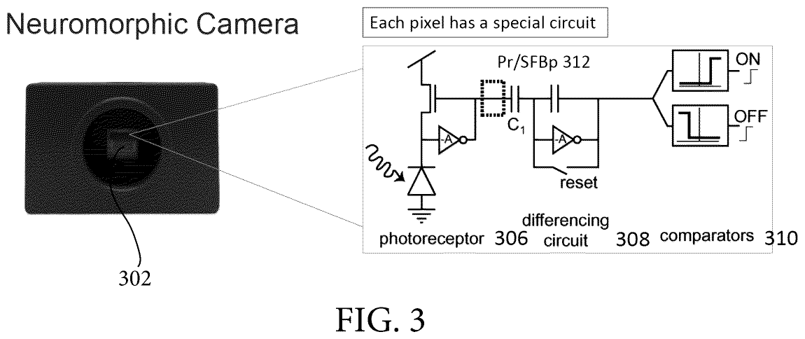

Certain exemplary aspects of the neuromorphic camera 106 of FIG. 1 are shown in greater detail in FIG. 3. The neuromorphic camera 106 may include an array of pixels 302. The array 302 may be sized, for example, as 346×260 pixels, but any possible array of pixels can be used in the neuromorphic camera 106. The neuromorphic camera 106 may increase the effective dynamic range of the system 100 as compared with a normal camera. In some embodiments, the neuromorphic camera 106 may have an effective dynamic range of 120 decibels (dB). The neuromorphic camera 106 may operate at a particular event speed. For example, in some embodiments, the neuromorphic camera 106 may be capable of operation at 12 million events/second. The neuromorphic camera 106 may couple to other external devices (e.g., a personal computing device, etc.) using one or more connections (e.g., a connection via a USB 3.0 micro B, etc.)

Still referring to FIG. 3, each pixel in the array of pixels 302 of the neuromorphic camera 106 may comprise an individual circuit 304, depicted schematically. The circuit 304 can include a photoreceptor 306, a differencing circuit 308, and one or more comparators 310. The photoreceptor 306, differencing circuit 308, and the one or more comparators 310 may form individual stages of the circuit 304. In some embodiments, the photoreceptor 306 may create a voltage signal based on light received at a photodiode. The differencing circuit 308 may remove absolute illumination information, and the comparators 310 may detect changes in the signal output from the photoreceptor 306 and the differencing circuit 308.

The photoreceptor 306 may include a photoreceptor bias and may stabilise the voltage across the photodiode and create a voltage signal which is proportional to the log of the light intensity (the “light-related signal”). This bias may control the amplifier in the first stage, and may limit a speed with which the output of the first stage can respond to changes. In some embodiments, an instantaneous change in illumination can cause a change in the light-related signal which takes a finite time to readjust. This finite time is highly variable (from μseconds to milliseconds) and can depend on multiple factors including the level of illumination and Pr bias. With low illumination and a sufficiently high Pr bias, adjustment time can be dictated by the light level. With high illumination or a low Pr bias, the adjustment time can be dictated by the Pr bias. A user may use the Pr bias to ensure that response time is slow. For a user to operate with a fast response time, the user may need both a high Pr bias and sufficient scene illumination. Additionally, the speed with which a pixel can respond to changes in light (the “bandwidth”) may be dictated by several factors; the Pr bias and the scene illumination are two of these factors. If the pixel bandwidth is high then the system may detect faster oscillations of illumination. However, it may also respond to higher frequency electronic noise, therefore producing more noise events (especially in low lighting conditions).

Some embodiments of the neuromorphic camera 106 may include a circuit between the photoreceptor 306 and the differencing circuit 308 that may pass a signal from the photoreceptor 306 to the differencing circuit 308 that reduces coupling from the differencing circuit 308 back to the photoreceptor 306. This circuit may be referred to as a Pr/SFBp circuit 312 (shown schematically). The bias created by the Pr/SFBp circuit 312 may dictate the speed at which this amplifier works. If the bias is set high, it could allow a high pixel bandwidth for fast detection, and at the same time, introduce increased in-band noise, and hence result in increased noise events. However, if the bias is low then it can limit the bandwidth of the pixel in much the same way as the Pr bias can.

The differencing circuit 308 may reject a DC component of a generated light-related signal whenever it is reset, so that the resulting signal doesn't carry information about the absolute level of illumination. Unlike the Pr bias which may have a complex interaction with illumination level, this bias may completely determine the speed at which the second stage adjusts to a change in the light-related signal. In embodiments, a magnitude of a change in illumination necessary to produce events may be set by varying biases for thresholds. These can be set independently for increases and decreases in illumination.

When a pixel is reset, the output of the second stage to the comparators may be a value set by a diff bias. Once the light-related signal changes, the value may change. In the incident of higher magnitudes of light, the value will increase and if there is less light then the value decreases. The change in this value can be proportional to the change in illumination, multiplied by the gain of the amplifier.

The diffOn bias can define the current level at which a pixel will produce an ON event. This must always be higher than then diff bias, and the ratio between the two defines the change in light level necessary to produce an event. Similarly, the diffOff bias can define the current level at which the pixel will produce an OFF event. This must always be lower than the diff bias, and the percentage change between the two can define the change in light level necessary to produce an event. In embodiments, because of mismatch, if either diffOn or diffOff is brought too close to diff then some pixels may malfunction.

The differencing circuit 308 may include a reset switch, which may simulate a refractory period of an optical nerve and can be referred to as a refractory bias. In embodiments, an event report may be generated, for example, when a light field for any given pixel crosses a threshold of intensity. This event report may signal to peripheral circuitry greater or less in one dimension than another. That is, the event reports may be reported asynchronously for each pixel when the light field intensity for that pixel exceeds a threshold. The event report can include, for example, a time-stamp, a pixel location, a polarity, etc.

This may take a finite amount of time, which can be less than 1 us, although when more than one pixel fires at a time, this time can extend due to queueing. Once a pixel receives an acknowledgment in both dimensions indicating that a communication was successful, it can reset itself with the reset switch. This reset can require a finite amount of time, which may be, at least partially, dictated by the diff bias. The refractory bias may define the time period during which the pixel will be reset, before it can again start to detect changes in the light-related signal coming from the first stage. Note that this does not stop the first stage from producing the light-related signal, which happens continuously. Changes that occur during the time it takes for a pixel to first communicate its event and then reset itself may generally be ignored.

Referring to the neuromorphic camera 106 generally, the photodiode and the transistors may contribute electronic noise. For example, even in a complete absence of light there may still be a small current across the photodiode, known as dark current. This dark current may have a certain amount of intrinsic noise. As light level increases, the noise in the photocurrent increases, but it does not do so exponentially, with the effect that there is less noise in the light-related signal, which represents the log of the photocurrent. Additionally, from a second stage onwards there may be significant amplification of the signal from the first stage. Any noise introduced to the signal may be ignorable compared to the contributions from the devices in the first stage. Further, a power of the electronic noise can be distributed across different frequency bands. Setting a higher threshold means that only larger deviations in the signal produce events, thus reducing sensitivity to noise at the expense of reducing the contrast sensitivity. If there is a lot of electronic noise, it may be seen that both ON and OFF events come from pixels. If there is less noise or high thresholds are set, an occasional ON event from a pixel, quickly followed by an OFF event, or vice versa, may be seen.

Active-pixel sensor (APS) cross talk can also be a source of noice. In some embodiments, when a global APS exposure is performed, there can be a burst of excessive events correlated with global APS exposure. These events have a typically noisy characteristic, although some correlation to expected activity can also be seen, i.e. pixels which were about to spike anyway may be induced to spike by the exposure. This can be caused by an undesirable coupling between certain nodes within the pixel. Reducing contrast sensitivity can help to reduce this problem.

Background events can also introduce noise. A strength of background noise can be related to background drift, which may also be strongly dependent on the amount of illumination-more illumination means more frequent events. In embodiments, there may be no way to eliminate entirely such events, although such frequency can be reduced by setting high thresholds. In some embodiments, a drift in the second stage that can lead to background events may also create a bias towards ON events. The more infrequently events are produced on average, the more noticeable this bias is. For some applications it may be useful to compensate for this with a higher ON threshold. If event rates are high on average then background events do not occur, because pixels do not have enough time to drift between spikes related to changes in scene illumination.

The neuromorphic camera 106 may include one or more features for adjusting optical settings of the camera. For example, the neuromorphic camera 106 may include a focus adjustment mechanism for adjusting various aspects of the focus and/or the field of view 112 (e.g., near/far, open/close, tele/wide, etc.) Additionally, the camera's position with respect to the scintillator 104 may be adjusted to adjust the view of the neuromorphic camera 106. In some embodiments, the event data captured by the neuromorphic camera 106 may be fused with image data from a frame-based camera (not shown) to generate fused data including the event data and frame-based data.

The object 108 may be any object and may, in some embodiments, be positioned on a sample platform 109. The sample platform 109 can include one or more features for moving a position or orientation of the object 108 with respect to the source 102, scintillator 104, and/or camera 106. For example, the sample platform 109 may rotate the object 108 with respect to the source 102 and the scintillator 104 such that different features within the object 108 are hit with the electromagnetic radiation from the source 102 and produce images based on the portions exposed to the electromagnetic radiation (e.g., x-rays, etc.) Embodiments are not limited by the arrangement shown in FIG. 1, however, and in some embodiments, the object 108 may be stationary (i.e., the sample platform 109 may not move position/orientation, etc.) and the source 102 and/or the scintillator 104 and camera 106 may move. During a scan of the object 108, the system 100 may obtain a plurality of raw data corresponding to the various angles (i.e., relative position/orientation) between the source 102, scintillator 104, camera 106, and object 108. In some embodiments, the relative position/orientation may be moved at least 30 degrees, 45 degrees, 90 degrees, 180 degrees, 270 degrees, 360 degrees, etc. in order to generate an image. In some embodiments, the relative position/orientation may rotate 180 degrees to obtain a cross-sectional image, for example.

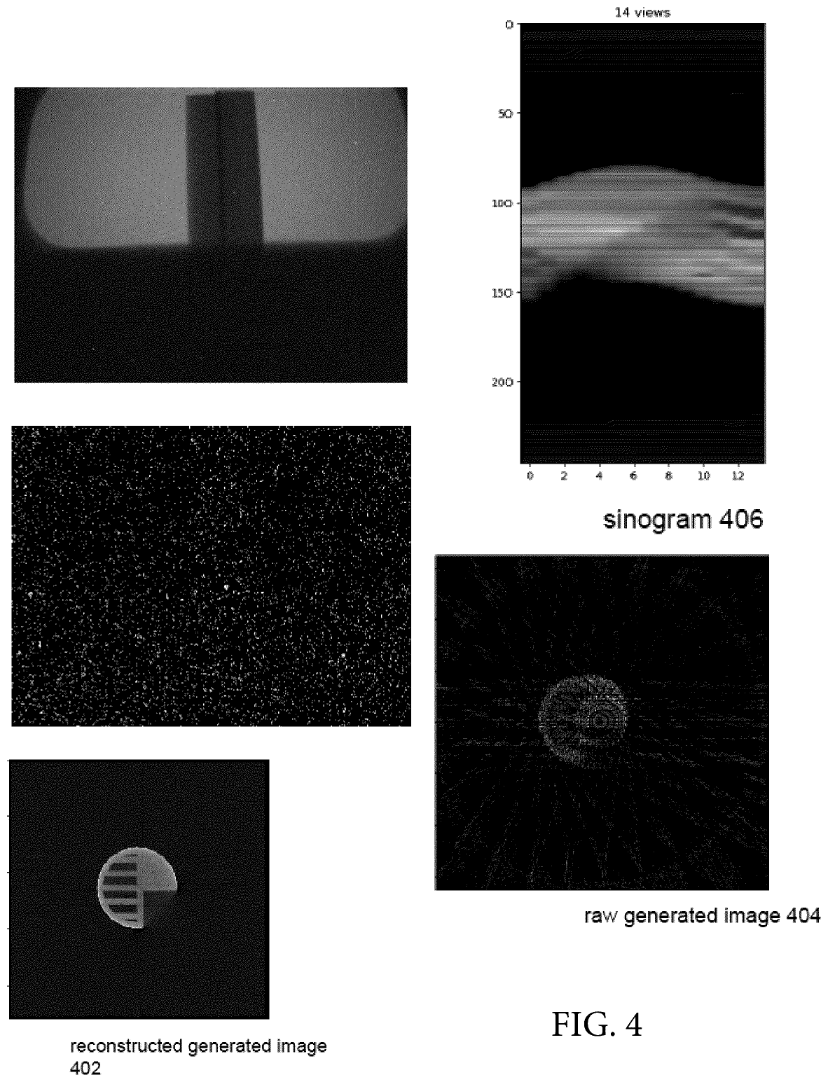

Referring to FIG. 4, a sinogram 406 may be acquired from a combination of the plurality of the raw data acquired by the system 100 of FIG. 1. The sinogram 406 may be acquired by performing a CT scan as the position/orientation of the components of the system 100 are moved with respect to one another for a given number of periods (e.g., one rotation, one-quarter rotation, etc.) The sinogram 406 corresponding to the one period may be used to produce a generated image such as raw generated image 404. The raw generated image 404 may include data captured by the neuromorphic camera 106 of FIG. 1. In some embodiments, the raw generated image 404 may be combined with other CT data (e.g., from a frame-based camera (not shown)) to generate a reconstructed generated image 402.

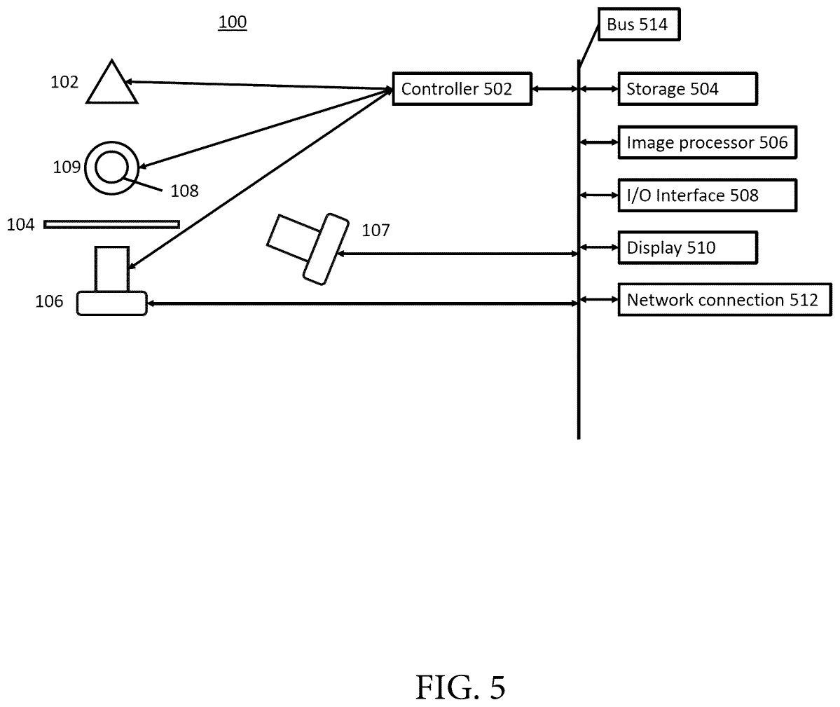

FIG. 5 shows a schematic including additional components of the system 100. In addition to the source 102, the sample platform 109, the scintillator 104, the camera 106, a conventional frame-based camera 107, and the other previously described features of the system 100, the system 100 may include a controller 502, a storage 504, an image processor 506, an input/output interface 508, a display 510, and a network connection 512. The various components and aspects of the system 100 may be coupled via a bus 514. It is to be noted that the components and features of the system 100 shown in FIG. 5 are not drawn to scale and are depicted schematically only. For example, the frame-based camera 107 could be within an emission field of the source in embodiments.

As described above, the object 108 may be positioned on the sample platform 109. In the present exemplary embodiment, the sample platform 109 may move in a predetermined direction (e.g., may move up, down, right, and left directions, rotate, etc.), and movement of the display platform 109 may be controlled by the controller 502. The sample platform 109 can receive a driving signal from the controller 502 and may move the object (not shown) accordingly. In some embodiments, one or more of the signals sent/received by the controller 502 and/or between other components of the system 100 may be sent wirelessly.

The source 102 may receive a voltage and current from the controller 502 and may generate and emit electromagnetic radiation (e.g., an x-ray). When the controller 502 (e.g., via a high voltage generating unit) applies predetermined voltage to the source 102, the source 102 may generate electromagnetic radiation corresponding to the predetermined voltage.

As described herein, the scintillator 104 may luminesce based on the incident radiation from the source 102 and the neuromorphic camera 106 may capture event data based on the luminescence. Accordingly, the camera 106 may be positioned such that its FOV includes the scintillator 104. The event data may be provided to one or more components of the system 100 via the bus 514. The event data can be provided either by wire or wirelessly.

The controller 502 may control an operation of each of the elements in the system 100. For example, the controller 502 may control operations of the display platform 109, the storage 504, the image processor 506, the I/O interface 508, the display 510, the network connection 512, or the like.

The image processor 506 may receive data acquired by one or more of the neuromorphic camera 106 and the frame-based camera 107 via the bus 514 and may perform various pre-processing and processing of the image data. Some examples of image pre-processing can include, for example, for sensitivities and signal loss. Data output from the image processor 506 may be raw data or processed data. This data can be stored in the storage 504 along with any other necessary system data (e.g., orientation angles, system voltage, etc.)

In some embodiments, the image processor 506 may post-process event data with position and orientation information from the source, specimen, and detector stages to output two-dimensional representations of the specimen internal structure as it evolves over time. In some embodiments, the image processor 506 may post-process event data with position and orientation information from the source, specimen, and detector stages to output three-dimensional representations of the specimen internal structure as it evolves over time.

The storage 504 may include any type of digital or analog storage media, including, but not limited to a flash memory-type storage medium, a hard disk-type storage medium, a multimedia card micro-type storage medium, card-type memories (e.g., an SD card, an XD memory, and the like), random access memory (RAM), static random access memory (SRAM), read-only memory (ROM), electrically erasable programmable ROM (EEPROM), programmable ROM (PROM), magnetic memory, a magnetic disc, and an optical disc.

In embodiments, the image processor 506 can reconstruct one or more images of the object 108 using the acquired data set. In some embodiments, the image processor 506 can fuse image data captured with the neuromorphic camera 106 with image data captured by the conventional frame-based camera 107 to generate a fused, reconstructed image or video. The generated images can be two-dimensional and/or three-dimensional images or video.

The I/O interface 508 may include one or more devices for receiving an input from an external source (e.g., a user). For example, the I/O interface 508 may include a microphone, a keyboard, a mouse, a joystick, a touch pad, a touch pen, a voice recognition device, a gesture recognition device, or the like. The I/O interface 508 may receive an external input with respect to various settings of the system 100 (e.g., input voltages, FOV settings, electromagnetic radiation settings, motion settings of the display platform 109, etc.)

The display 510 may display one or more of raw data, processed data, images, reconstructed images, and other aspects of the system 100. The bus 514 can use one or more of electrical, optical, wireless communication or other signal to communicate data, voltage, current, or other signal between components. The network connection 512 may perform communication with an external device (e.g., server, a cloud connection, etc.)

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A neuromorphic radiography and computed tomography system comprising
a source of electromagnetic radiation;
a scintillator, capable of fluorescing when struck by the electromagnetic radiation emitted by the source; and
a neuromorphic camera comprising an array of pixels and having a field of view and configured to generate event data based on the fluorescence generated by the scintillator, wherein
the source emits the electromagnetic radiation in a field directed at an object and the object effects aspects of the electromagnetic radiation field,
the scintillator receives the electromagnetic radiation and luminesces based on the receipt of the electromagnetic radiation,
the luminescence of the scintillator is captured by the neuromorphic camera to generate event data associated with luminescence events within the scintillator, wherein event data is generated each time an incidence of luminescence exceeds a threshold level of light within the field of view
the event data is processed to generate a reconstruction of the object.

2. The neuromorphic radiography and computed tomography system of claim 1, wherein neuromorphic camera reports an event asynchronously for each pixel when the light field intensity for that pixel exceeds a threshold.

3. The neuromorphic radiography and computed tomography system of claim 2, wherein the event report includes a time-stamp, pixel location, and polarity.

4. The neuromorphic radiography and computed tomography system of claim 3, wherein the event data is post-processed with position and orientation information from the source, specimen, and detector stages to output two-dimensional representations of the specimen internal structure as it evolves over time.

5. The neuromorphic radiography and computed tomography system of claim 3, wherein the event data is post-processed with position and orientation information from the source, specimen, and detector stages to output three-dimensional representations of the specimen internal structure as it evolves over time.

6. The neuromorphic radiography and computed tomography system of claim 1, wherein the event data is fused with data generated by a frame-based camera.

7. The neuromorphic radiography and computed tomography system of claim 1, wherein the generated reconstruction of the object is displayed on a display.
